(19) United States
(12) Patent Application Publication
(10) Pub. No.: US 2016/0203738 A1
(43) Pub. Date: Jul. 14, 2016

(54) APPARATUS AND METHOD FOR TEACHING INTUSSUSCEPTION REDUCTION

(71) Applicant: THE CHILDREN'S HOSPITAL OF PHILADELPHIA, Philadelphia, PA (US)

(72) Inventors: Victor Ho-Fung, Philadelphia, PA (US); Maria Alejandra Bedoya Velez, Philadelphia, PA (US); Jorge Delgado, Philadelphia, PA (US); Janet Reid, Solon, OH (US)

(73) Assignee: The Children's Hospital of Philadelphia, Philapdelphia, PA (US)

(21) Appl. No.: 14/916,395

(22) PCT Filed: Sep. 4, 2014
(86) PCT No.: PCT/US2014/054033

§ 371 Date: Mar. 3, 2016

Related U.S. Application Data
(60) Provisional application No. 61/873,473, filed on Sep. 4, 2013.

(51) Int. Cl. G09B 23/30

(52) U.S. Cl. CPC G09B 23/30

(57) ABSTRACT

A system for practicing an intussusception reduction procedure includes a flexible tube. The flexible tube can include an open end and a closed end A source of fluid pressure can be configured to be fluidly connected with the open end. The system can also include an imaging machine for obtaining real-time images of the flexible tube. Moreover, the system can include a visual barrier surrounding at least one portion of the flexible tube. A method for practicing an intussusception reduction procedure can include connecting a flexible tube to a source of fluid pressure, and insufflating the flexible tube with a fluid from the source of fluid pressure until the tube expands.

### RELATED APPLICATIONS

This application claims the benefit of priority of U.S. Application Ser. No. 61/873,473, filed Sep. 4, 2013, the content of which is incorporated by reference herein in its entirety.

### FIELD

The present invention relates generally to teaching apparatuses and training techniques, and more specifically to apparatuses and methods for teaching medical professionals how to perform an intussusception reduction procedure.

### BACKGROUND

Bowel intussusception is a serious condition that can cause acute abdominal pain in children. The condition is characterized by the invagination of a bowel and mesenteric tissue into an adjacent bowel portion. Invagination of the bowel is often observed as a portion of the bowel that “telescopes” or folds itself inside another portion of the bowel. This telescoping can create an obstruction that blocks solids and fluid from passing through the bowel. Intussusception can also cut off the blood supply to the obstructed part of the intestine. If intussusception is not promptly treated, the condition can lead to a tear in the bowel (perforation), infection and death of bowel tissue. In some cases, the condition can lead to death. Therefore, bowel intussusception is considered an emergency that requires immediate treatment.

Children with bowel intussusception often complain of acute abdominal pain and may exhibit bloody diarrhea or stool. These symptoms are common and may or may not be indicative of a serious condition like bowel intussusception. To diagnose these symptoms, doctors often request an ultrasound examination of the child's abdomen. In such cases, the radiologist evaluating the ultrasound examination often becomes the first individual to learn when a bowel intussusception is present.

Bowel intussusception in children can be treated through open surgery. Surgery has drawbacks, however, because surgery is invasive, requires the use of general anesthesia, and carries the risk of infection. In addition, if the bowel intussusception is detected by the radiologist, then surgery requires the patient to be transported from the radiology room to another room, or even another building, where the surgery can be performed. Transporting the child to surgery can cost precious time.

In many cases, surgery can be avoided by having the radiologist treat the bowel intussusception using a minimally invasive procedure known as “intussusception reduction.” In intussusception reduction, fluid pressure is introduced into the bowel with fluoroscopic guidance to unfold or push the bowel back to its normal state. This procedure is a radiologic procedure that can be performed by the radiologist promptly after diagnosis, saving time and avoiding the drawbacks of surgery. Unfortunately, bowel intussusception is not observed frequently enough by radiologists to allow them to develop skills for treating the condition. There are very few opportunities for radiologists to participate in intussusception reduction procedures and acquire the requisite training and hand-eye coordination needed to perform the procedure safely and successfully.

### SUMMARY

In one beneficial aspect, an apparatus for practicing an intussusception reduction procedure includes a flexible tube comprising an open end and a closed end.

In another beneficial aspect, an apparatus for practicing an intussusception reduction procedure includes a flexible tube, and a source of fluid pressure configured to be fluidly connected with the flexible tube.

In another beneficial aspect, a system for practicing an intussusception reduction procedure includes a flexible tube having an open end and a closed end, a source of fluid pressure configured to be fluidly connected with the open end of the flexible tube, and an imaging machine for obtaining real-time images of the flexible tube.

In another beneficial aspect, a system for practicing an intussusception reduction procedure includes a flexible tube and a structure around the flexible tube.

In another beneficial aspect, a system for practicing an intussusception reduction procedure includes a flexible tube and a visual barrier. The visual barrier can include an enclosure surrounding at least a portion of the flexible tube. The enclosure can include a mannequin of the human abdomen.

In another beneficial aspect, the flexible tube can be formed of a synthetic bowel material.

In another beneficial aspect, the source of fluid pressure can be a quantity of air or a quantity of liquid. Where a quantity of liquid is used, the quantity of liquid is stored above the flexible tube at a static pressure head.

In another beneficial aspect, the source of fluid pressure can be a contrast material. The contrast material can be barium.

In another beneficial aspect, the imaging machine can include x-ray fluoroscopy equipment. In addition, or in the alternative, the imaging machine can include ultrasound imaging equipment.

In another beneficial aspect, the open end of the of flexible tube can be configured to be directly connected with the source of fluid pressure. In such embodiments, the open end of the flexible tube can be configured to be directly connected with the source of fluid pressure in a fluid tight seal.

In another beneficial aspect, the source of fluid pressure can include a connector tube having a first end for connection to the open end of the flexible tube, and a second end. In such embodiments, the connector tube can be an enema tube.

In another beneficial aspect, the source of fluid pressure can include a flexible hose connected with the second end of the connector tube.

In another beneficial aspect, the source of fluid pressure can include a bulb connected to the connector tube.

In another beneficial aspect, the source of fluid pressure can include a source of compressed gas connected to the connector tube.

In another beneficial aspect, the source of fluid pressure can include a container of liquid connected to the connector tube.

In another beneficial aspect, the source of fluid pressure can include a pressure relief valve.

In another beneficial aspect, the system or apparatus can include at least one weight for creating a simulated obstruction at a section of the flexible tube.

In another beneficial aspect, the flexible tube is formed of a synthetic bowel material.

In another beneficial aspect, the flexible tube is a double walled tube.

In another beneficial aspect, the open end of the flexible tube is configured for fluid connection with an intussusception kit.

In another beneficial aspect, the open end of the flexible tube can be configured to be directly connected with a source of fluid pressure.

In another beneficial aspect, the open end of the of flexible tube can be configured to be directly connected with the source of fluid pressure in a fluid tight seal.

In another beneficial aspect, a method for practicing an intussusception reduction procedure can include the step of connecting an apparatus to a source of fluid pressure, the apparatus comprising a flexible tube comprising an open end, a closed end, and a tube body extending between the open end and the closed end, the open end connected to the source of fluid pressure, and the tube body arranged to have at least one folded section that forms a constriction in the tube body.

In another beneficial aspect, a method for practicing an intussusception reduction procedure can include the step of insufflating the flexible tube with a fluid from a source of fluid pressure until the constriction expands.

In another beneficial aspect, a method for practicing an intussusception reduction procedure can include using an apparatus that visually obstructs the flexible tube, and positioning the apparatus in front of imaging equipment so that the constriction in the tube body is visible on a monitor associated with the imaging equipment.

In another beneficial aspect, a method for practicing an intussusception reduction procedure can include the step of monitoring a constriction in the tube body in real time on the monitor.

In another beneficial aspect, a method for practicing an intussusception reduction procedure can include the step of monitoring a condition of a constriction in the tube body on the monitor in real time as the constriction expands.

In another beneficial aspect, a method for practicing an intussusception reduction procedure can include the step of insufflating the flexible tube with fluid from the source of fluid pressure until a folded section is completely unfolded and the obstruction is removed.

In another beneficial aspect, a method for practicing an intussusception reduction procedure can include the step of ceasing the insufflation of a flexible tube immediately after a constriction expands.

In another beneficial aspect, a step of insufflating a flexible tube includes compressing an elastic bulb to pump air into the flexible tube until a constriction expands.

In another beneficial aspect, a step of insufflating a flexible tube includes discharging liquid from a container into the flexible tube until the constriction expands.

In another beneficial aspect, the step of insufflating a flexible tube includes discharging gas under pressure into the flexible tube until a constriction expands.

### BRIEF DESCRIPTION OF THE DRAWINGS

The foregoing summary and the following detailed description will be better understood in conjunction with the non-limiting examples shown in the drawing figures, of which:

FIG. 1 is a perspective view of a system for practicing an intussusception reduction procedure in accordance with an exemplary embodiment of the invention;

FIG. 2 is a perspective view of another system for practicing an intussusception reduction procedure in accordance with an exemplary embodiment of the invention;

FIG. 3 is a perspective view of another system for practicing an intussusception reduction procedure in accordance with an exemplary embodiment of the invention;

FIG. 4 is a perspective view of another system for practicing an intussusception reduction procedure in accordance with an exemplary embodiment of the invention;

FIG. 5 is a block flow diagram describing steps for practicing an intussusception reduction procedure in accordance with an exemplary embodiment of the invention; and

FIG. 6 is another block flow diagram describing steps for practicing an intussusception reduction procedure in accordance with an exemplary embodiment of the invention.

### DETAILED DESCRIPTION

Although the invention is illustrated and described herein with reference to specific embodiments, the invention is not intended to be limited to the details shown. Rather, various modifications may be made in the details within the scope and range of equivalents of the claims and without departing from the invention.

Applicants have developed apparatuses, systems and methods for teaching radiologists and other health professionals (hereinafter, “students”) about intussusception reduction. Students can use the apparatuses, systems and methods to learn the skills that are required for performing intussusception reduction, and practice techniques for completing a successful reduction. The apparatuses, systems and methods utilize physical models and equipment that test the student's abilities and help the students practice skills, including skills necessary for using the equipment, preparing the patient, and hand-eye coordination for performing the procedure.

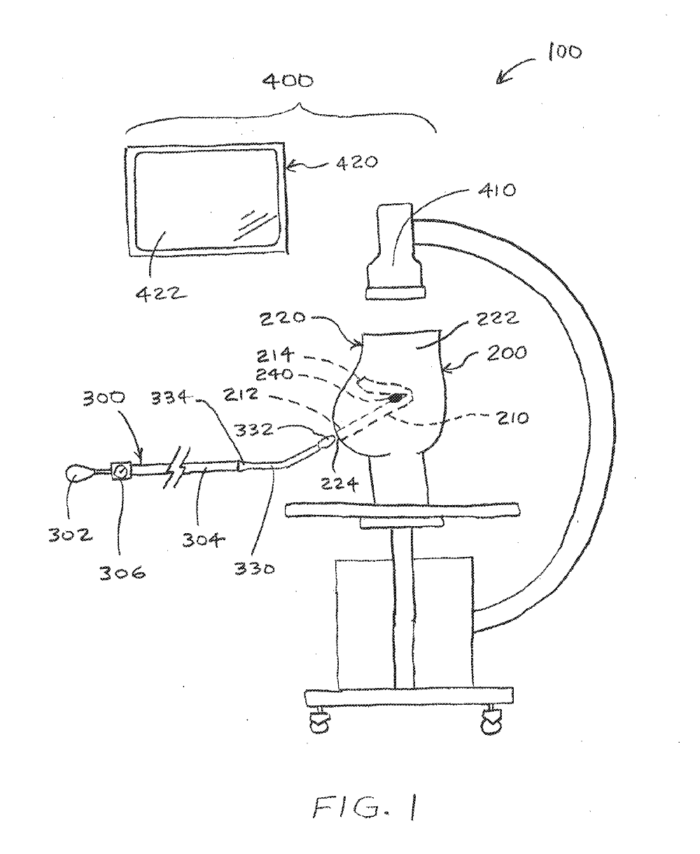

Referring to FIG. 1, a system 100 for practicing an intussusception reduction procedure is shown. System 100 includes an apparatus 200 for practicing an intussusception reduction procedure, a source of fluid pressure 300, and imaging equipment 400. Apparatus 200 includes a flexible tube 210 that represents a bowel to be treated. Flexible tube 210 may be formed of a variety of flexible reinforced or non-reinforced tubular materials, including a synthetic bowel material, such as the materials used in simulated bowels manufactured by The Chamberlain Group or Simulab Corporation. In addition, flexible tube may be formed of a single walled material, a double walled material, or other construct that replicates the thickness and flexibility of the human bowel. Flexible tube 210 includes an open end 212 and a closed end 214.

A visual barrier 220 surrounds at least one portion of flexible tube 210. Visual barrier 220 serves as a visual obstruction between the student and flexible tube 210, so that the folded portion of the tube is not visible to the naked eye during a simulated bowel intussusception procedure. Visual barrier 220 may be in the form of an enclosure that surrounds at least one portion of flexible tube 210. In FIG. 1, for example, visual barrier 220 is in the form of a plastic mannequin or model 222 molded in the shape of a child's abdomen. Mannequin 222 provides a hands-on teaching tool that provides opportunities to learn basic but important skills needed to perform a bowel intussusception procedure. The mannequin 222 teaches students how to properly position a patient during a procedure, and how to insert an enema tube into a patient, among other skills.

In some circumstances, it may be desirable to practice intussusception techniques without a visual barrier. For example, it may be beneficial for students that are beginning their training to use a flexible tube and no barrier, or a flexible tube behind a transparent or translucent barrier, so that the students can directly observe the flexible tube as it begins to expand in response to fluid pressure building in the flexible tube. This can help the students see the rate of expansion and learn how to regulate the source of fluid pressure. For these applications, systems and apparatuses in accordance with the invention can simply include a flexible tube with no barrier, enclosure or other structure around the tube. Alternatively, systems and apparatuses in accordance with the invention can include a flexible tube and a transparent or translucent structure around the tube. For example, mannequin 222 in FIG. 1 can be formed of a transparent or translucent material. The transparent or translucent structure can also be in the form of a transparent or translucent box, case or other structure. The structure around the flexible tube can also be an opaque structure with a transparent or translucent section, such as a window, that allows the interior of the structure to be seen from outside the structure. These structures allow the student to practice connecting the apparatus to the source of fluid pressure, while still being able to directly observe the condition of the flexible tube without the need for imaging equipment.

Open end 212 of flexible tube 210 is configured for connection with the source of fluid pressure 300. The term “source of fluid pressure” as used herein, means any component or system that delivers a fluid so as to simulate insufflation of a human bowel. For example, the source of fluid pressure 300 may be in the form of a commercially available intussusception air reduction kit. In FIG. 1, source of fluid pressure 300 includes a bulb 302, a flexible hose 304, a pressure gauge 306 and a connector tube 330. Connector tube 330 is shown in the form of an enema tube, which can be used in actual intussusception reduction procedures. Connector tube 330 can also have other tube configurations. Connector tube 330 has a first end 332 that connects with the flexible tube 210 and a second end 334 that connects with flexible hose 304.

Open end 212 of flexible tube 210 is configured to be directly connected with source of fluid pressure 300. In particular, first end 332 of connector tube 330 is configured for insertion into open end 212 of flexible tube 212. Open end 212 of flexible tube 210 is exposed and accessible through an opening 224 in mannequin 222. Opening 224 may form a substantially tight seal around first end 332 of connector tube 330 when the connector tube is inserted into flexible tube 210. The seal prevents or substantially prevents fluid from escaping out of the apparatus during insufflation of flexible tube 210. Alternatively, the size of open end 212 can be purposefully designed so that that the open end is larger than first end 332 of connector tube 330, and does not form a tight seal around the first end of the connector tube. The latter configuration provides additional learning opportunities for the student, as it requires the student to practice creating a seal around the open end 212 of flexible tube 210, using tape or other means, which is often required during an actual intussusception reduction procedure.

Bowel intussusception is often caused by lymph nodes that become enlarged and push against a portion of the intestine, causing the intestine to telescope or fold. The presence of enlarged lymph nodes can make reduction more difficult, as the lymph nodes can cause resistance that prevents the folded section of intestine from unfolding. To simulate the presence of lymph nodes, apparatus 200 can include one or more weights 240 adjacent to flexible tube 210 that create simulated obstructions. Weights 240 may be in the form of plastic pellets, beads or other objects having a size and mass sufficient enough to bear against flexible tube 210 and induce a fold in the flexible tube.

Imaging equipment 400 includes an x-ray fluoroscope 410 and a video monitor 420. X-ray fluoroscope 410 is configured to capture real-time images of flexible tube 210 inside mannequin 222 during a simulated intussusception reduction procedure. Video monitor 420 is connected with x-ray fluoroscope 410 to receive a video signal and display the real-time image of flexible tube 210 on a screen 422.

To set up the system 100, apparatus 200 can be positioned on a table, such as a C-arm fluoroscopy table as shown. Apparatus 200 is shown in FIG. 1 in an upright position on the table, with mannequin 222 oriented with the leg portions of the mannequin standing on the table. This is only to illustrate the profile shape of the mannequin, not how the apparatus should be positioned during a simulated intussusception reduction procedure. During a simulated procedure, apparatus 200 can be oriented in other positions on the table. For example, apparatus 200 can be oriented so that mannequin 222 lays on its side. The table and apparatus 200 are positioned so that the radiologist can reach the mannequin 222 and source of fluid pressure 300. Monitor 420 should be in the radiologists field of view, and is preferably located where the radiologist can direct his or her line of sight while being able to see model 222 and source of fluid pressure 300 in his or her peripheral vision. In this arrangement, system 100 is set up so that the radiologist can activate and deactivate source of fluid pressure 300 during a simulated insufflation, while monitoring the condition of flexible tube 210 on monitor 420.

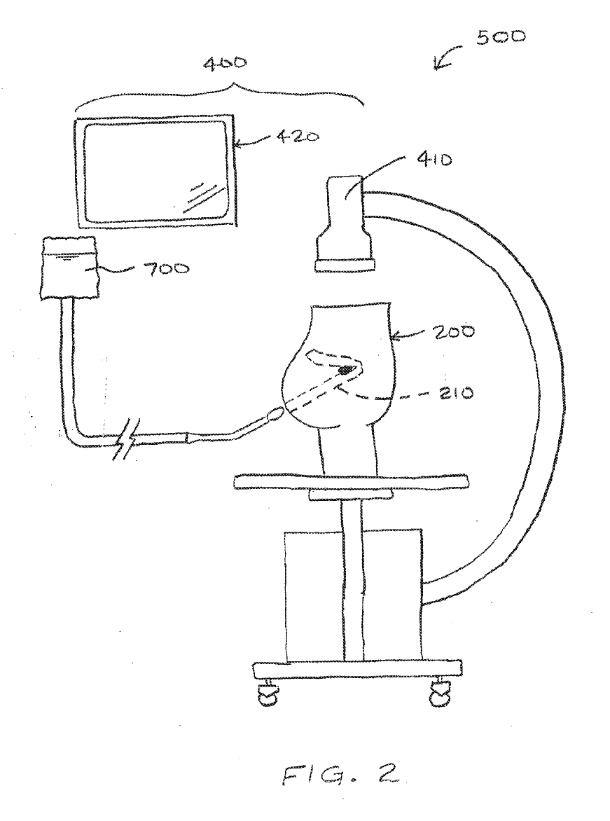

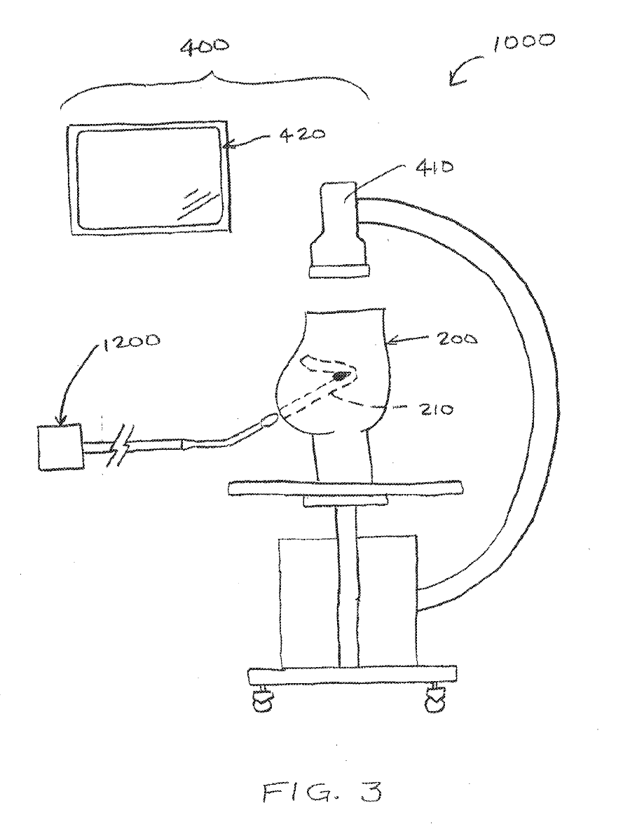

Source of fluid pressure 300 delivers compressed air into flexible tube 210. Other types of fluid may be used to insufflate the flexible tube, however. For example, FIG. 2 illustrates an alternative system 500 that features a source of fluid pressure 700 in the form of bag of liquid, such as water. The water is stored above flexible tube 210 at a static pressure head. FIG. 3 illustrates another alternative system 1000 that features a source of fluid pressure 1200 that delivers a contrast material, such as barium, into apparatus 200.

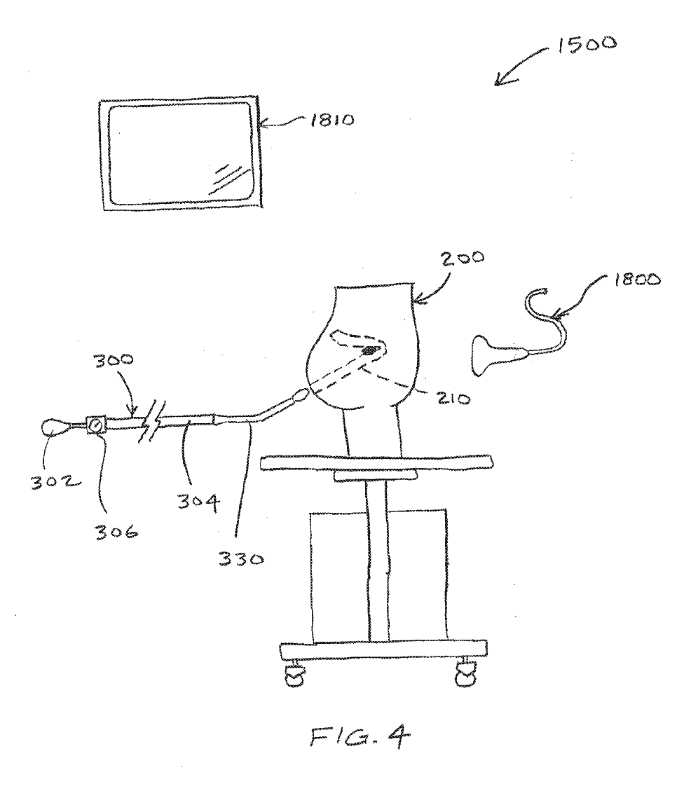

Systems in accordance with the invention need not utilize x-ray fluoroscopy equipment. Other types of imaging equipment may be used. For example, FIG. 4 illustrates an alternative system 1500 that utilizes an ultrasound transducer 1800 and monitor 1810.

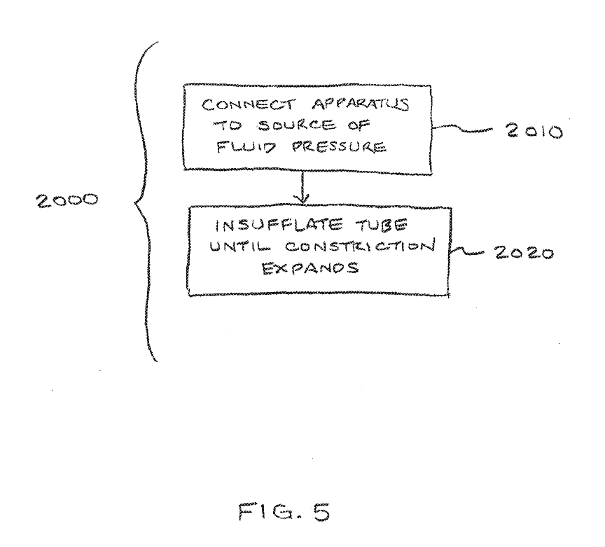

Referring now to FIG. 5, a method 2000 for practicing an intussusception reduction procedure will be described. FIG. 5 is a very general outline of steps for using systems in accordance with the invention. In a first step 2010, an apparatus is connected to a source of fluid pressure. The apparatus may simply be a flexible tube that is closed at one end and open at another end, with the open end connected to a source of fluid pressure. Alternatively, the apparatus may be one of the mannequin apparatuses previously described and shown in the other drawing figures. The flexible tube includes at least one section that is folded, telescoped, or otherwise arranged to form a constriction in the tube body.

In step 2020, the flexible tube is insufflated with a fluid from a source of fluid pressure until the constriction expands.

The steps shown in method 2000 can be practiced to demonstrate how an intussusception reduction procedure works at a basic level. For example, the flexible tube may be insufflated without a visual barrier to demonstrate how rapidly the simulated bowel unfolds in response to insufflation, thereby helping students become familiar with the source of fluid pressure and how it operates at different flow rates. Additional steps may be performed in addition to those summarized in FIG. 5 to help students learn other aspects of an intussusception reduction procedure.

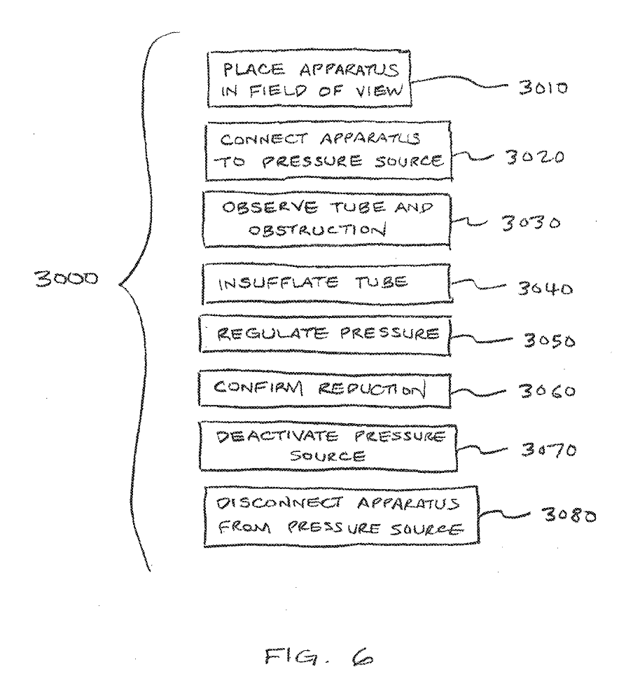

Referring now to FIG. 6, another method 3000 is described with additional steps. It should be understood that FIG. 6 represents only one possible sequence of steps for simulating an intussusception reduction procedure in accordance with the invention. Some steps shown in the diagram in FIG. 6 can be performed in other sequences in accordance with the invention, and some steps may be omitted. In addition, there may be other steps added to the sequence of steps to simulate an intussusception procedure.

In a first step 3010, an apparatus is placed in the field of view of imaging equipment. For example, the apparatus can be placed on a C-arm fluoroscopy table. In step 3020, the apparatus is connected to a source of fluid pressure. This is accomplished, for example, by attaching the connector tube to the open end of the flexible tube. Preferably, the connector tube is inserted into the open end of the flexible tube and taped to provide a fluid tight seal. Where a mannequin is used, the mannequin allows students to practice proper insertion of the connector tube and form a seal using tape or other means.

In step 3030, the condition of the tube and the obstruction is observed in real time on a monitor associated with the imaging equipment. The apparatus should be positioned so that the image displayed on the monitor includes at least the obstructed section of the flexible tube. More preferably, the image displayed on the monitor includes a substantial portion of the flexible tube.

In step 3040, the source of fluid pressure is activated to begin insufflating the flexible tube. The particular method for “activating” of the source of fluid pressure depends on the type of fluid being introduced. Where air pressure is used, the student can compress a bulb repeatedly to pump air into the flexible tube. Where water or other liquid is introduced by gravity, or by a source under pressure, the student can open a valve, release a hose clamp, manually release a tube that is being pinched closed, or otherwise open a liquid pathway between the source of fluid pressure and the flexible tube. Where contrast agent is used, the student can open a valve to release contrast agent into the flexible tube.

The student can observe the condition of the flexible tube and the obstruction on the monitor in real time as the source of fluid pressure is activated, and as the flexible tube begins to expand in response to fluid pressure building inside the flexible tube. In step 3050, the fluid pressure in the flexible tube is regulated. The release of fluid can be regulated (i.e. increased or decreased) based on a number of conditions. For example, the fluid pressure can be regulated based on the observed rate of expansion of the flexible tube. If the rate of expansion observed on the monitor appears to be too rapid, this can indicate that an amount of pressure was reached inside the flexible tube that would be too high and unsafe in an actual intussusception reduction procedure. Visual feedback provided by the monitor is particularly instructive in teaching the student how to safely activate and regulate the source of fluid pressure and avoid introducing too much fluid pressure into the patient. Fluid pressure can also be monitored and regulated using a pressure gauge connected to the line coming from the source of fluid pressure.

In step 3060, reduction of the intussusception is confirmed based on the condition of the flexible tube observed on the monitor. This may be confirmed by observing the monitor and confirming that the folded section is substantially or completely unfolded, or confirming that the telescoped section has expanded. Once the reduction is confirmed, the source of fluid pressure is deactivated in step 3070. In step 3080, the apparatus is disconnected from the source of fluid pressure. This can be done by removing any tape that sealed the connection between the connector tube and flexible tube, and withdrawing the connector tube from the apparatus.

### Intussusception Simulation Device Testing and Survey Data

An intussusception simulation device in accordance with the invention was tested by a group of voluntary participants consisting of eight pediatric radiology fellows and two radiology residents. Participants completed an initial survey to disclose their prior experience with intussusception reduction (“Pre-Confidence Questionnaire”). The median number of weeks of formal pediatric radiology training among participants was 11.5 weeks. Sixty percent of participants reported having seen fewer than 5 cases of intussusception prior to the survey, while thirty percent reported seeing 5-10 cases, and ten percent reported seeing 10-30 cases. Forty percent of participants reported having no formal training in intussusception air reductions.

The participants completed a motor skill test using the intussusception simulation device and standard fluoroscopic equipment (“Pre-Skill Test”). Following the Pre-Skill Test, participants attended a lecture describing fluoroscopic technique and assembly of the intussusception kit. Following the lecture, participants took a second survey using on a Likert scale to evaluate the usefulness of the intussusception simulation device (“Post-Confidence Questionnaire”). Participants were asked to rate their own skill or comfort level in different areas before and after training. The Post-Confidence Questionnaire revealed an increase in the median confidence level in the following areas: overall skill in assembling the intussusception air reduction kit, operation of the fluoroscopy machine, and performing a rectal seal. In addition, the minimum and maximum scores remained constant or increased in the following areas: operating a manometer device, monitoring intussusception reduction under fluoroscopy, and identifying successful reduction. When asked whether the simulated training increased their confidence in intussusception reduction, fifty percent responded that they agreed, and fifty percent reported that they strongly agreed.

While preferred embodiments of the invention have been shown and described herein, it will be understood that such embodiments are provided by way of example only. Numerous variations, changes and substitutions will occur to those skilled in the art without departing from the invention. The appended claims cover all such variations as fall within the scope of the invention.

1. A system for practicing an intussusception reduction procedure, the system comprising:
a flexible tube comprising an open end and a closed end; and
a source of fluid pressure configured to be fluidly connected with the open end of the flexible tube.

2. The system of claim 1, further comprising a visual barrier.

3. The system of claim 2, wherein the visual barrier comprises an enclosure surrounding at least a portion of the flexible tube.

4. The system of claim 3, wherein the enclosure comprises a mannequin of the human abdomen.

5. The system of claim 1, wherein the flexible tube is formed of a synthetic bowel material.

6. (canceled)

7. (canceled)

8. The system of claim 1, wherein the source of fluid pressure is stored above the flexible tube at a static pressure head.

9. The system of claim 1, wherein the source of fluid pressure comprises a contrast material.

10. The system of claim 9, wherein the contrast material comprises barium.

11. The system of claim 1 comprising an imaging machine for obtaining real-time images of the flexible tube.

12. The system of claim 11, wherein the imaging machine comprises ultrasound imaging equipment or x-ray fluoroscopy equipment.

13. The system of claim 1, wherein the open end of the of flexible tube is configured to be directly connected with the source of fluid pressure.

14. (canceled)

15. The system of claim 1, wherein the source of fluid pressure further comprises a connector tube having a first end for connection to the open end of the flexible tube, and a second end.

16. (canceled)

17. The system of claim 15, wherein the source of fluid pressure further comprises a flexible hose connected with the second end of the connector tube.

18. The system of claim 15, wherein the source of fluid pressure comprises a bulb connected to the connector tube.

19. The system of claim 15, wherein the source of fluid pressure comprises a source of compressed gas connected to the connector tube.

20. The system of claim 15, wherein the source of fluid pressure comprises a container of liquid connected to the connector tube.

21. (canceled)

22. The system of claim 1 further comprising at least one weight for creating a simulated obstruction at a section of the flexible tube.

23-26. (canceled)

27. The system of claim 1, wherein the flexible tube is a double walled tube.

28. The system of claim 1, wherein the open end of the flexible tube is configured for fluid connection with an intussusception kit.

29-31. (canceled)

32. A method for practicing an intussusception reduction procedure, the method comprising the steps of:
A) connecting an apparatus to a source of fluid pressure, the apparatus comprising a mannequin of the human bowel that comprises a flexible tube comprising an open end, a closed end, and a tube body extending between the open end and the closed end, the open end connected to said source of fluid pressure, and the tube body arranged to have at least one folded section that forms a constriction in the tube body; and
B) insufflating the flexible tube with a fluid from said source of fluid pressure until the constriction expands.

33. The method of claim 32, further comprising the step of: C) positioning the apparatus in front of imaging equipment so that the constriction in the tube body is visible on a monitor associated with the imaging equipment.

34. The method of claim 33, further comprising the step of: D) monitoring the constriction in the tube body in real time on the monitor.

35-41. (canceled)
